(19) United States
(12) Patent Application Publication
(10) Pub. No.: US 2025/0376208 A1
(43) Pub. Date: Dec. 11, 2025

(54) FOLDING MULTI-PERSON STROLLER/WAGON

(71) Applicant: WonderFold Corporation, Irwindale, CA (US)

(72) Inventors: Jaekook Lim, Guangzhou (CN); Huang Xuhui, Guangzhou (CN)

(21) Appl. No.: 18/961,257

(22) Filed: Nov. 26, 2024

Related U.S. Application Data
(63) Continuation-in-part of application No. 29/946,767, filed on Jun. 11, 2024.

(51) Int. Cl. B62B 7/10; B62B 9/14

(52) U.S. Cl. CPC B62B 7/105; B62B 9/142

(57) ABSTRACT

A wagon including a frame or base is provided. The frame is supported by a plurality of wheels and the wagon further includes a first rotatable rod and a second rotatable rod connected to a front end of the frame and each rotatable with respect to the frame, a third rotatable rod and a fourth rotatable rod connected to a rear end of the frame and each rotatable with respect to the frame, a first rotatable, disengageable, and collapsable connecting arm arrangement rotatably mounted with the first rotatable rod and the third rotatable rod, and a second rotatable, disengageable, and collapsable connecting arm arrangement rotatably mounted with the second rotatable rod and the fourth rotatable rod.

The present application claims priority based on Chinese Utility Model patent application Ser. No. 20/232,3215304.3, filing date Nov. 28, 2024, entitled “A baby stroller that is easy to store and fold,” inventors Jaekook Lim and Huang Xuhui, and U.S. Design patent Application Ser. No. 29/946,767, filed Jun. 11, 2024, inventor Huang Xuhui, the entireties of which are incorporated herein by reference.

### BACKGROUND

### I. Field

The present invention relates generally to the field of strollers or wagons, and more specifically to a stroller or wagon device that folds into a relatively compact configuration.

### II. Background

Many types of baby strollers or wagons are available on the market, the most common ones are single-seat and double-seat strollers or wagons. The single-seat is suitable for one child, and the double-seat for two children. Strollers or wagons currently used for multiple children tend to have relatively complex structures due to the size of such a vehicle as well as the need to support two children. To provide comfort and safety for the two children, the strollers or wagons are typically equipped with additional accessories and facilities, such as coverings, safety belts and handrails, which increase the weight of the body and the occupied area.

In general, it is not convenient to fold and store previous strollers or wagons for two children for storage such as in an automobile.

It would be beneficial to provide a stroller or wagon that overcomes issues with prior stroller designs.

### SUMMARY

The following presents a simplified summary in order to provide a basic understanding of some aspects of the claimed subject matter. This summary is not an extensive overview, and is not intended to identify key/critical elements or to delineate the scope of the claimed subject matter. Its sole purpose is to present some concepts in a simplified form as a prelude to the more detailed description that is presented later.

According to one embodiment of the present design, there is provided a vehicle comprising a frame attached to a plurality of wheels, a first rotatable element and a second rotatable element connected to a front end of the frame and each rotatable with respect to the frame, a third rotatable element and a fourth rotatable element connected to a rear end of the frame and each rotatable with respect to the frame, a first rotatable, disengageable, and collapsable connecting arm arrangement rotatably mounted with the first rotatable element and the third rotatable element, a second rotatable, disengageable, and collapsable connecting arm arrangement rotatably mounted with the second rotatable element and the fourth rotatable element, and an enclosure attached to the frame.

According to a further embodiment of the present design, there is provided a wagon comprising a frame, a plurality of wheels positioned beneath the frame, a first rotatable rod and a second rotatable rod connected to a front end of the frame and each rotatable with respect to the frame, a third rotatable rod and a fourth rotatable rod connected to a rear end of the frame and each rotatable with respect to the frame, a first rotatable, disengageable, and collapsable connecting arm arrangement rotatably mounted with the first rotatable rod and the third rotatable rod; a second rotatable, disengageable, and collapsable connecting arm arrangement rotatably mounted with the second rotatable rod and the fourth rotatable rod, and an enclosure positionable above the frame within an area bounded by the first rotatable rod, the second rotatable rod, the third rotatable rod, and the fourth rotatable rod.

According to another embodiment of the present design, there is provided a wagon comprising a frame supported by a plurality of wheels, a first rotatable rod and a second rotatable rod connected to a front end of the frame and each rotatable with respect to the frame, a third rotatable rod and a fourth rotatable rod connected to a rear end of the frame and each rotatable with respect to the frame, a first rotatable, disengageable, and collapsable connecting arm arrangement rotatably mounted with the first rotatable rod and the third rotatable rod, and a second rotatable, disengageable, and collapsable connecting arm arrangement rotatably mounted with the second rotatable rod and the fourth rotatable rod.

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings.

### BRIEF DESCRIPTION OF THE DRAWINGS

FIG. 1 illustrates the structure of the first embodiment;

FIG. 2 is the frame structure of the first embodiment;

FIG. 3 shows the seat back when the maximum tilt angle of the seat back is adjusted according to the present design;

FIG. 4 is a diagram of the exploded structure of the third joint component of the first embodiment of the design;

FIG. 5 illustrates the structure of the second vertical rod of the design when folded;

FIG. 6 shows a diagram of the structure of the first vertical rod and the second vertical rod of the design when folded;

FIG. 7 represents a folded version of the first embodiment of the design;

FIG. 8 is a perspective view of an alternate embodiment of the design;

FIG. 9 is a left side view of this alternate embodiment;

FIG. 10 is a right side view of the alternate embodiment;

FIG. 11 is a front view of the stroller or wagon according to the alternate embodiment;

FIG. 12 is a rear view of the stroller or wagon according to the alternate embodiment;

FIG. 13 is a top view of the alternate embodiment; and

FIG. 14 is a bottom view of the alternate embodiment;

FIG. 15 is a view of a joint or connector, completely engaged, that may be employed in the present design;

FIG. 16 shows the joint or connector completely disengaged;

FIG. 17 illustrates the joint or connector partially engaged;

FIG. 18A shows a conceptual representation of one side of the riding bag or enclosure in a closed orientation; and

FIG. 18B shows a conceptual representation of the one side of the riding bag or enclosure in an open orientation.

### DETAILED DESCRIPTION

In this document, the words “embodiment,” “variant,” and similar expressions are used to refer to particular apparatus, process, or article of manufacture, and not necessarily to the same apparatus, process, or article of manufacture. Thus, “one embodiment” (or a similar expression) used in one place or context can refer to a particular apparatus, process, or article of manufacture; the same or a similar expression in a different place can refer to a different apparatus, process, or article of manufacture. The expression “alternative embodiment” and similar phrases are used to indicate one of a number of different possible embodiments. The number of possible embodiments is not necessarily limited to two or any other quantity.

The word “exemplary” is used herein to mean “serving as an example, instance, or illustration.” Any embodiment or variant described herein as “exemplary” is not necessarily to be construed as preferred or advantageous over other embodiments or variants. All of the embodiments and variants described in this description are exemplary embodiments and variants provided to enable persons skilled in the art to make or use the invention, and not to limit the scope of legal protection afforded the invention, which is defined by the claims and their equivalents.

Described embodiments are only some of the embodiments of the present invention, not all of them. If directional indications are provided (such as up, down, left, right, front, back, top, bottom, inner, outer, vertical, transverse, longitudinal, counterclockwise, clockwise, circumferential, radial, axial . . . ), the directional indication is only used to explain the relative positional relationship, movement conditions, etc. When the specific posture changes, the directional indication also changes accordingly.

A description related to “the first” or “the second” etc. in an embodiment are for descriptive purposes only and are not to be construed as indicating or implying their relative importance or implying the number of technical characteristics indicated. Thus, features defined as “first” and “second” may expressly or implicitly include up to one or more fewer features. In addition, the technical solutions of the various embodiments can be combined with each other.

According to a first embodiment of the present design, there is provided a stroller or wagon that is relatively easy to store and fold. According to the first embodiment, there is provided a wagon or stroller having a side rod configured to cooperate with a first vertical rod, a second vertical rod, a bottom frame and a side rod. In this configuration the side rod can be rotated and folded, and the first vertical rod and the second vertical rod can be folded on a bottom frame, thereby driving a riding bag to be folded and stored, reducing the occupied area of the frame when not in use.

The design provides a stroller or wagon that is easy to store and fold, comprising a frame and a boat-like riding bag installed on the frame, two seats being installed inside the riding bag, the frame comprising a bottom frame with movable wheels, one end of the bottom frame being rotatably installed with two first vertical rods, the other end of the bottom frame being installed with two rotatable second vertical rods. The upper end between the two first vertical rods and the upper end between the two second vertical rods are both jointed with a connecting rod. Both sides of the two seats are respectively connected to the first vertical rod and the second vertical rod through a first joint part. A backrest of the seat can adjust the inclination angle of the backrest through the first joint part. The joint between the first vertical rod and the second vertical rod is provided with a rotatable and foldable side rod. The two ends of the side rod are movably connected with support rods. A roof is installed between the two support rods, and the upper end joint between the two first vertical rods is provided with a push handle.

The side rod may include a first cross rod and a second cross rod. A first hinge seat may be installed at one end of the first cross rod, the first hinge seat is installed at the upper end of the second vertical rod. One end of the second cross rod may be connected to the outer wall joint of the first vertical rod, where the first cross rod and the second cross rod are connected by a third joint.

The third joint component may include a circular first connecting seat and a second connecting seat. The first connecting seat may be fixed to the other end of the second cross bar. The second connecting seat may be fixed to the other end of the first cross bar. A rotating shaft may be installed inside the second connecting seat. A socket may be opened inside the first connecting seat for inserting one end of the rotating shaft.

A sleeve may be fixed on the side of the first connecting seat and the second connecting seat away from the rotating shaft. One end of the sleeve on the first connecting seat and the second connecting seat may be respectively sleeved and fixed on the first cross bar and the second cross bar. The other end of the sleeve may be provided with an arc-shaped notch for the first cross bar and the second cross bar to expand and limit the position.

A second hinge seat may be installed at the lower end of the second vertical rod, and the second hinge seat may be connected to the outer wall at the corner of the bottom frame.

A fifth hinged seat may be installed at the corner of the opposite end of the bottom frame. The lower end joint of the first vertical rod may be provided on the fifth hinged seat. The upper end of the first vertical rod in this embodiment may be installed with a second joint component. The two ends of the push handle may be respectively installed on the second joint components on the two first vertical rods. The structure of the first joint component and the structure of the second joint component may be the same as the structure of the third joint component.

A fourth hinged seat may also be installed on the outer wall of the lower end of the first vertical rod. A bracket may be provided at the joint between the two fourth hinged seats, and a storage bag is installed on the bracket.

The design operates to enable the side bars to be rotated and folded in cooperation with the first vertical bar, the second vertical bar, the bottom frame and the side bars. The first vertical bar and the second vertical bar can be folded on the bottom frame, thereby folding and storing the riding bag or riding area, reducing the size of the wagon or stroller when not in use.

The design may be employed with two or up to four children by arranging two single or double seats in the riding bag or riding enclosure or area. The inclination of the seat backrest can be adjusted by the first joint part so that the frame can be directly folded and stored without disassembling the seats, increasing the convenience of folding and storing.

The design may include a detachable roof, canopy, or ceiling, detachable by movably inserting or engaging the support rod and the side rod. This configuration can be convenient for flexible installation and removal of the roof, canopy, or ceiling, again making the wagon or stroller more convenient for use.

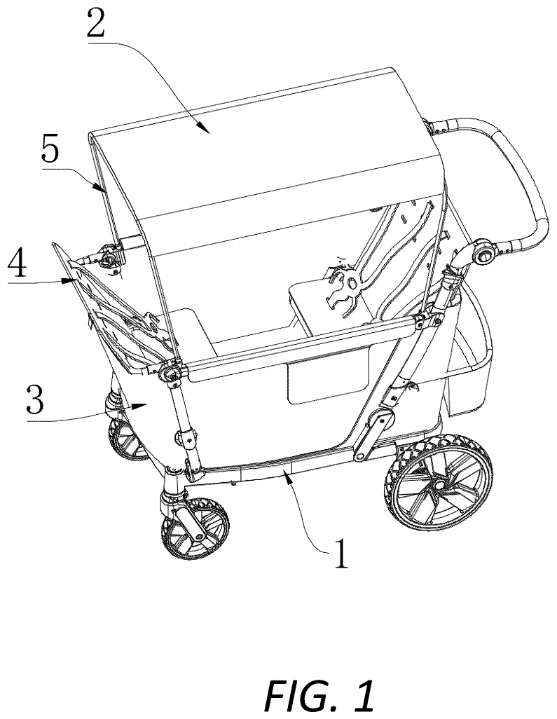

FIG. 1 illustrates the first embodiment, a baby stroller that is easy to store and fold, including a frame 1 and a boat-like riding bag 3 or riding enclosure installed on the frame 1. The design further includes two single or double seats 4 installed inside the riding bag 3. The frame 1 includes a bottom frame 101 with moving wheels. One end of the bottom frame 101 may be rotatably mounted with two first vertical rods 103. The other end of the bottom frame 101 may be mounted with two rotatable second vertical rods 109. The upper end between the two first vertical rods 103 and the two second vertical rods 109 may be connected to the bottom frame 101. The upper ends of the two seats 4 may be connected to the first vertical rod 103 and the second vertical rod 109 respectively at the joints. The backrests of the seats 4 can adjust the inclination angle of the backrests through the first joints 102. The joints between the first vertical rod 103 and the second vertical rod 109 may be provided with rotatable and foldable side rods 110. The two ends of the side rods 110 may be movably connected with support rods 5. A cover or ceiling 2 may be installed between the two support rods 5. The upper end joints between the two first vertical rods 103 may be provided with a push handle 105.

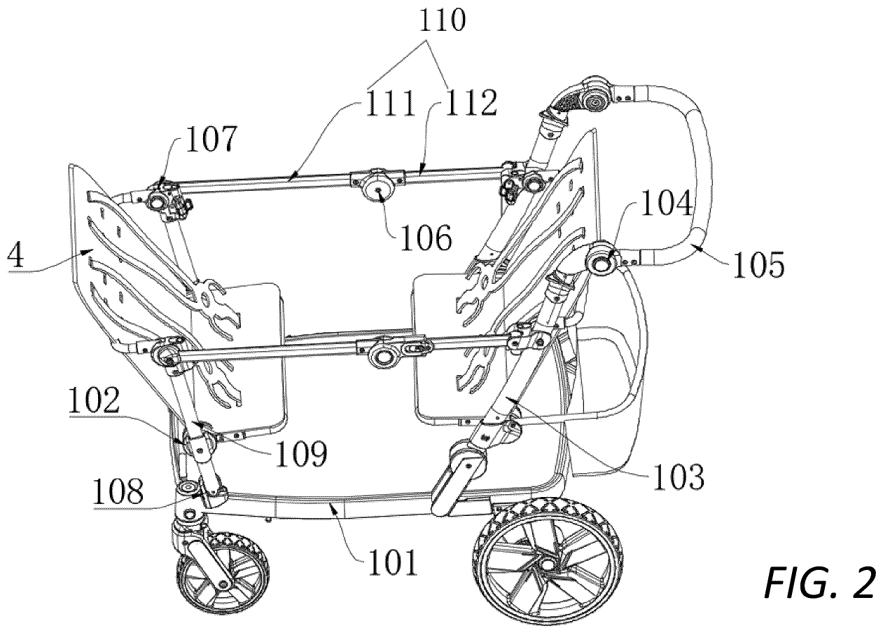

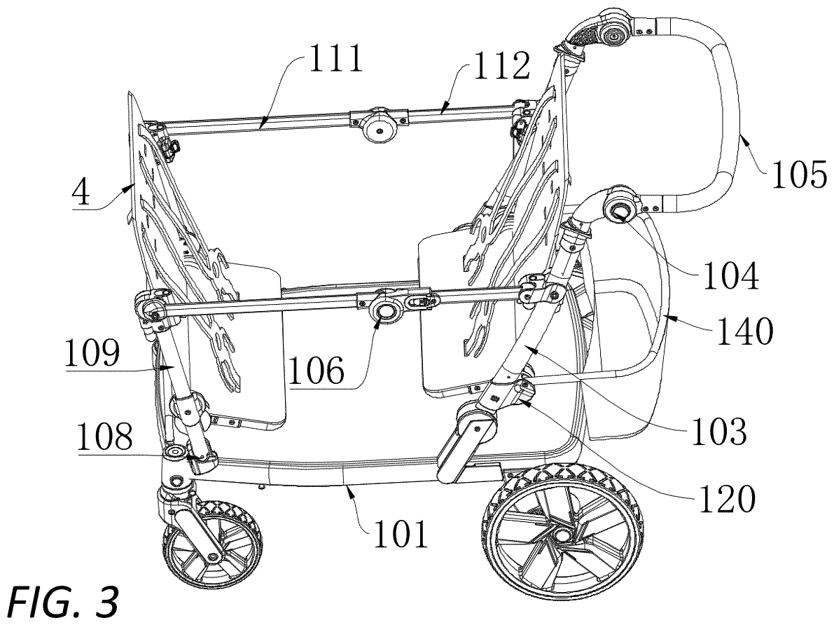

FIGS. 2 and 3 show the side rod 110 including a first cross bar 111 and a second cross bar 112. A first hinge seat 107 may be installed at one end of the first cross bar 111. The first hinge seat 107 may be installed at the upper end of the second vertical rod 109. One end of the second cross bar 112 may be connected to the outer wall joint of the first vertical rod 103. The first cross bar 111 and the second cross bar 112 may be connected by a third joint 106 so that the first cross bar 111 and the second cross bar 112 can be rotated and folded with the first joint 102 as the center when folded and stored.

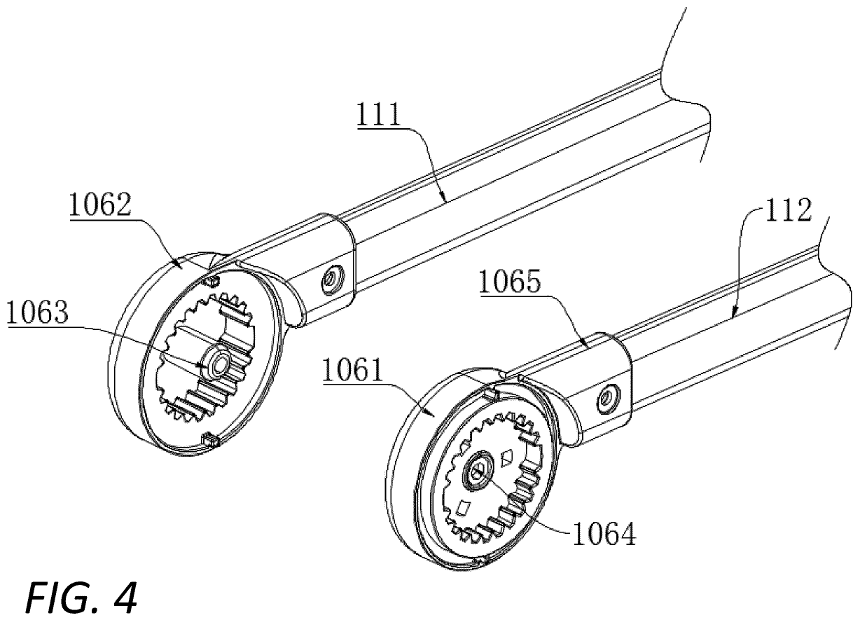

As shown in FIG. 4, the third joint component 106 may include a circular first connecting seat 1061 and a second connecting seat 1062. The first connecting seat 1061 may be fixed to the other end of the second cross bar 112. The second connecting seat 1062 may be fixed to the other end of the first cross bar 111. A rotating shaft 1063 may be installed inside the second connecting seat 1062, and a socket 1064 may be provided inside the first connecting seat 1061 for inserting one end of the rotating shaft 1063 to facilitate the joint connection of the first cross bar 111 and the second cross bar 112 by plugging the rotating shaft 1063 into the socket 1064.

A sleeve 1065 may be fixed on one side of the first connecting seat 1061 and the second connecting seat 1062 away from the rotating shaft 1063. One end of the sleeve 1065 on the first connecting seat 1061 and the second connecting seat 1062 may be respectively sleeved and fixed on the first cross bar 111 and the second cross bar 112. The other end of the sleeve 1065 may be provided with an arc-shaped notch for the first cross bar 111 and the second cross bar 112 to expand and limit the position, so as to facilitate the first vertical bar 103 and the second vertical bar 109 to be folded on the bottom frame 101 after the first cross bar 111 and the second cross bar 112 are folded.

A second hinge seat 108 may be installed at the lower end of the second vertical rod 109. The second hinge seat 108 may be connected to the outer wall at the corner of the bottom frame 101 so that the second vertical rod 109 can be turned over and folded with the second hinge seat 108 as the axis.

A fifth hinge seat 130 may be installed at the corner of the other end of the bottom frame 101, the lower end joint of the first vertical rod 103 may be on the fifth hinge seat 130, and the upper end of the first vertical rod 103 may be installed with a second joint part 104. Both ends of the push handle 105 may be respectively installed on the second joint parts 104 on the two first vertical rods 103. The structure of the first joint part 102 and the structure of the second joint part 104 may be the same as the structure of the third joint part 106 so that the first vertical rod 103 can be rotated and folded with the second joint part 104 as the axis. In this arrangement, the first vertical rod 103 can drive the push handle 105 to fold on the bottom frame 101.

The first joint 102, the second joint 104, and the third joint 106 may all be provided with buttons for limiting the position when folding or unfolding. The first articulated seat 107, the second articulated seat 108, the fourth articulated seat 120, and the fifth articulated seat 130 may all be installed with joints or only some may include such joints. The joints may also be provided with buttons for limiting the position when folding or unfolding. The working principle of the joints may be similar to the working principle of the folding joints used in prior baby strollers. One example of such folding joints is disclosed in patent document application number CN201910249580.0, the entirety of which is incorporated herein by reference.

A fourth hinged seat 120 may also be installed on the outer wall of the lower end of the first vertical rod 103. A bracket 140 may be provided at the joint between the two fourth hinged seats 120. A storage bag may be installed on the bracket 140. The storage bag may be supported by the bracket 140, and items are stored in the storage bag, such as baby necessities or food containers. Through the joint between the bracket 140 and the fourth hinged seat 120, the bracket 140 can be folded and rotated with the fourth hinged seat 120 as the axis. Such an arrangement facilitates folding and storing the bracket 140.

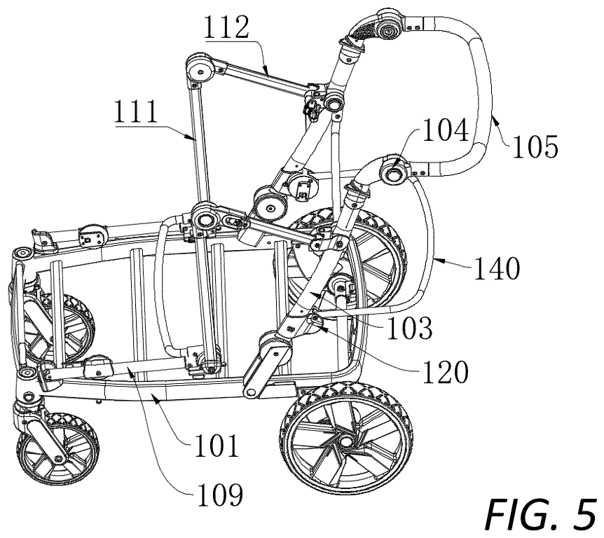

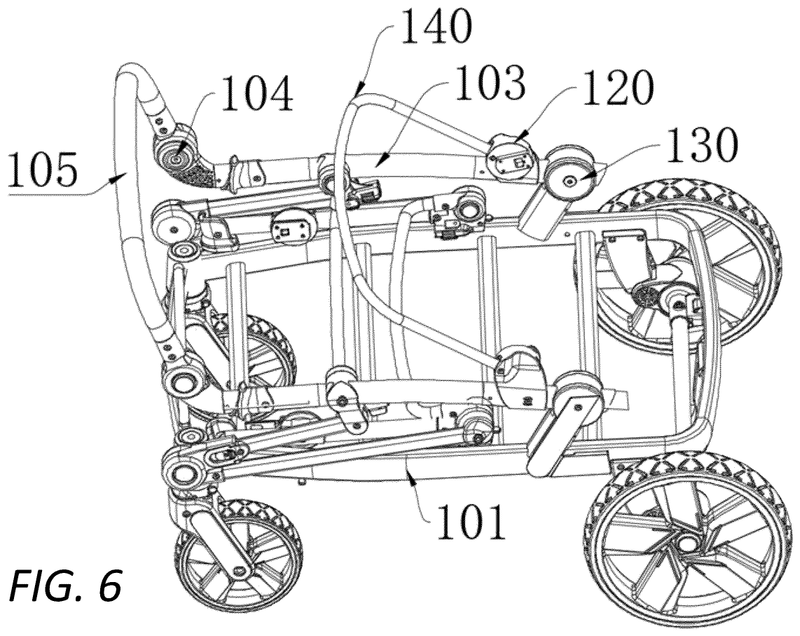

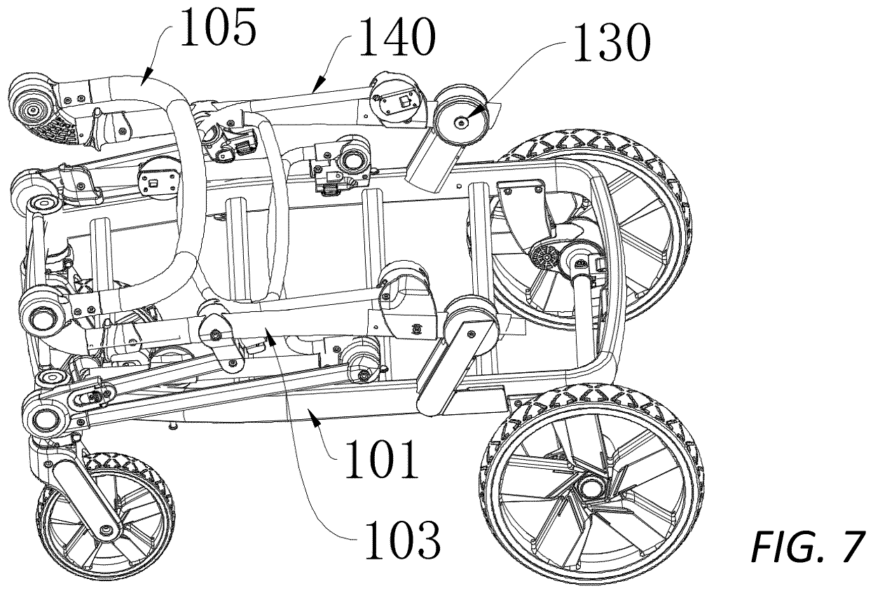

When folding and storing, first press the button at the first hinge seat 107 to fold the connecting rods 6 at both ends of the riding bag 3 downward, as shown in FIG. 3, then apply force upward from the third joint 106, the first cross bar 111 rotates the folding side rod 110 around the third joint 106, and then the second vertical rod 109 is turned over and folded on the bottom frame 101, driving the left seat 4 to fold toward the middle, as shown in FIG. 5, and then the first vertical rod 103 is turned over and folded on the bottom frame 101, so that the first vertical rod 103 and the second vertical rod 109 are folded and tilted in relative directions, so that the right seat 4 is folded toward the middle, as shown in FIG. 6, and finally the bracket 140 is folded and stored at the first vertical rod 103, and then the push handle 105 is folded so that the push handle 105 presses the bracket 140, and the state shown in FIG. 7 is the folded state. The riding bag 3 is folded and stored by the folding frame 1, thereby reducing the occupied area of the baby stroller when not in use and improving the convenience of folding and storing the baby stroller. In addition, the two seats 4 arranged in the riding bag 3 can be suitable for twin babies to sit on, and the backrest inclination of the seat 4 can be adjusted by the first joint 102, so that the frame 1 does not need to disassemble the seat 4 when folding and storing, and can be directly folded and stored, thereby improving the convenience of folding and storing; through the movable connection between the support rod 5 and the side rod 110, the roof 2 is detachable, which is convenient for flexible installation and removal of the roof 2 according to actual use requirements, thereby improving the convenience of use.

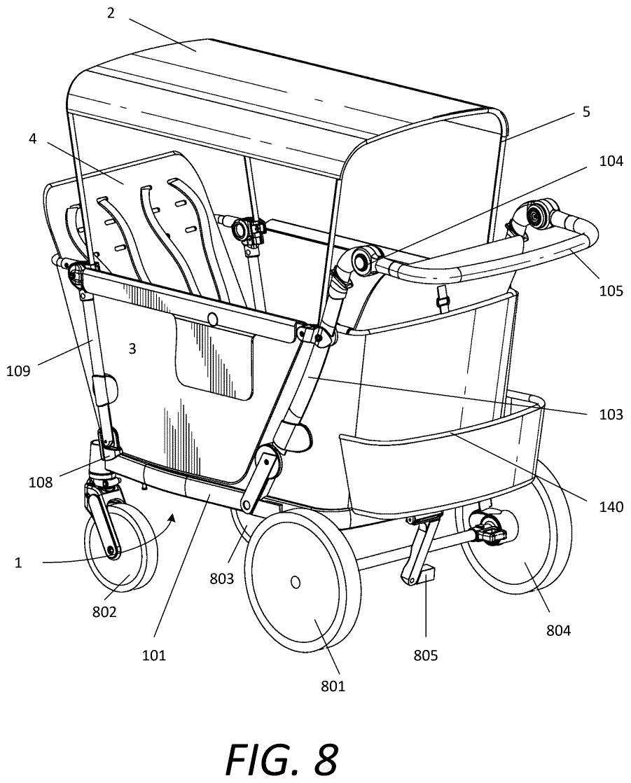

FIG. 8 shows a perspective view of an alternate embodiment of the present design and includes roof 2, seat 4, support rod 5, riding bag or enclosure 3, frame 1, and in this view wheels 801, 802, 803, and 804. Also presented is the seat facing seat 4, enabling four small children to ride in the stroller or wagon, where in this view each seat is presented with securing elements similar to a seatbelt or harness. Alternate seats may be provided, such as single seats rather than dual or tandem seats.

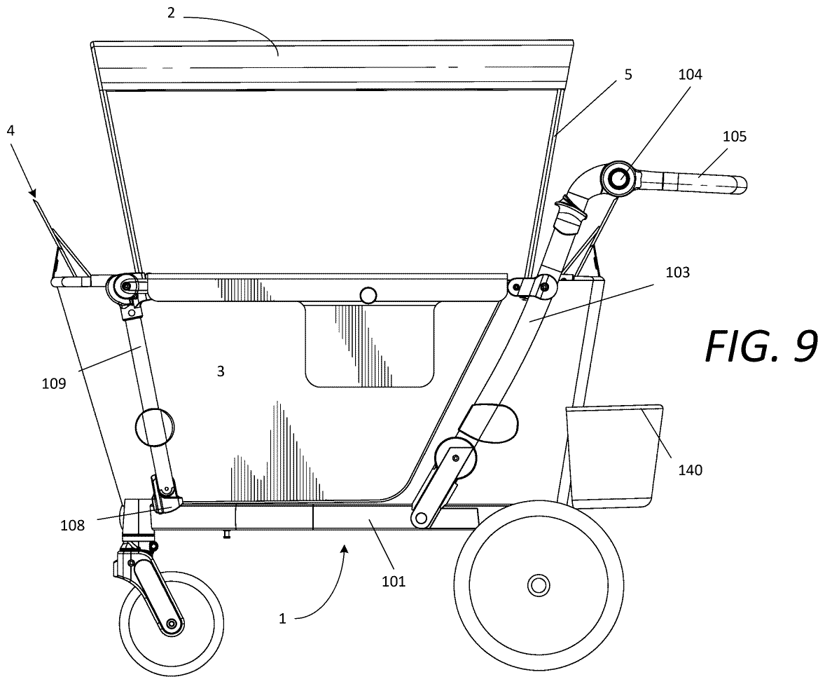

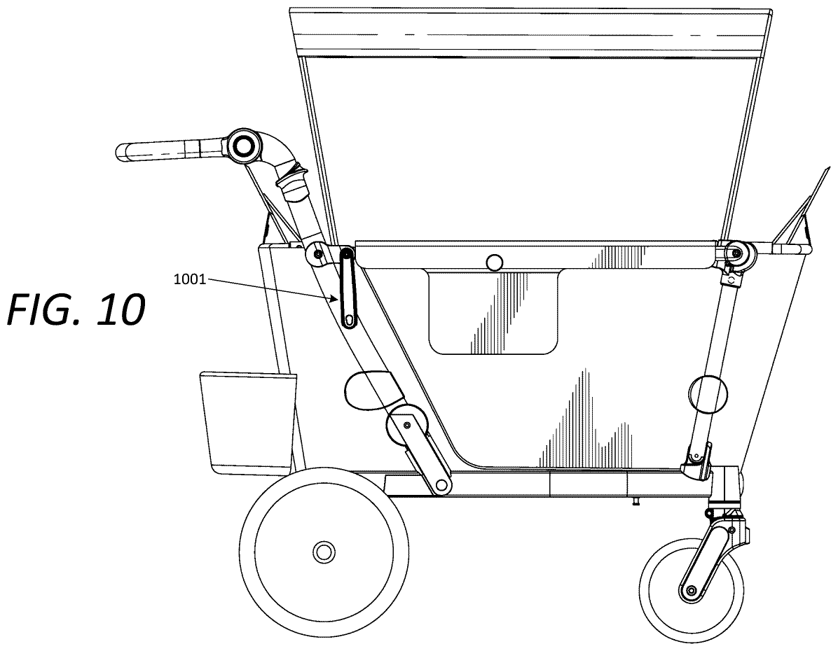

Also in FIG. 8 are bottom frame 101, first vertical rod 103, second joint 104, push handle 105, second articulated seat 108, second vertical rod 109, and fourth hinged seat 120. Bracket 140 with a storage bag provided is also presented. Element 805 may allow for a handle to be attached for pulling the wagon or stroller or may be used to slow or impede the rotation of the rear axle. FIG. 9 is a left side view of this alternate embodiment, showing roof 2, seat 4, support rod 5, riding bag or container 3, and frame 1 including bottom frame 101. First vertical rod 103, second joint 104, push handle 105, second articulated seat 108, second vertical rod 109, and bracket 140 with a storage bag provided are also presented. FIG. 10 is a right side view of this alternate embodiment having many similar components to those illustrated in FIG. 9, but also including a connection element 1001 that serves to enhance stability of the vehicle, wagon, or stroller.

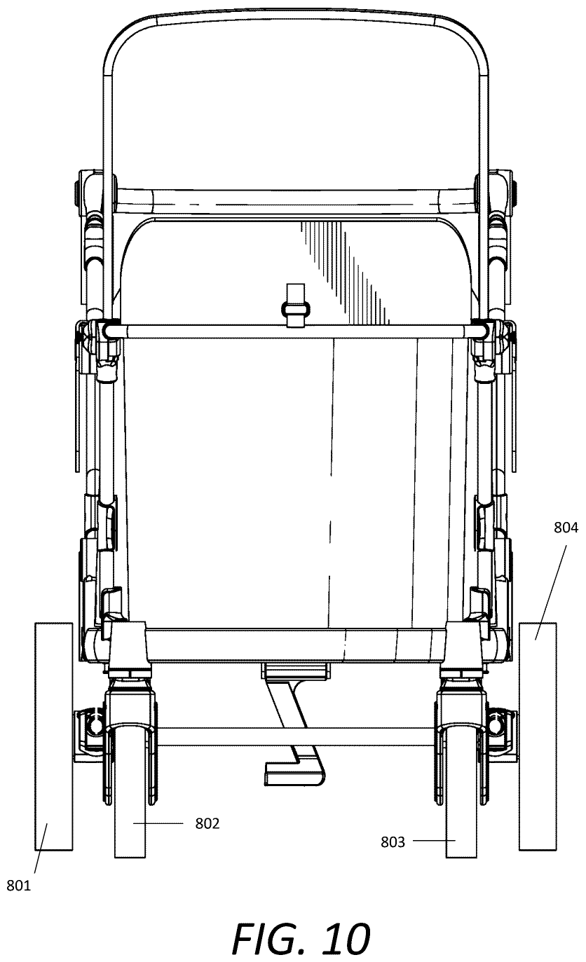

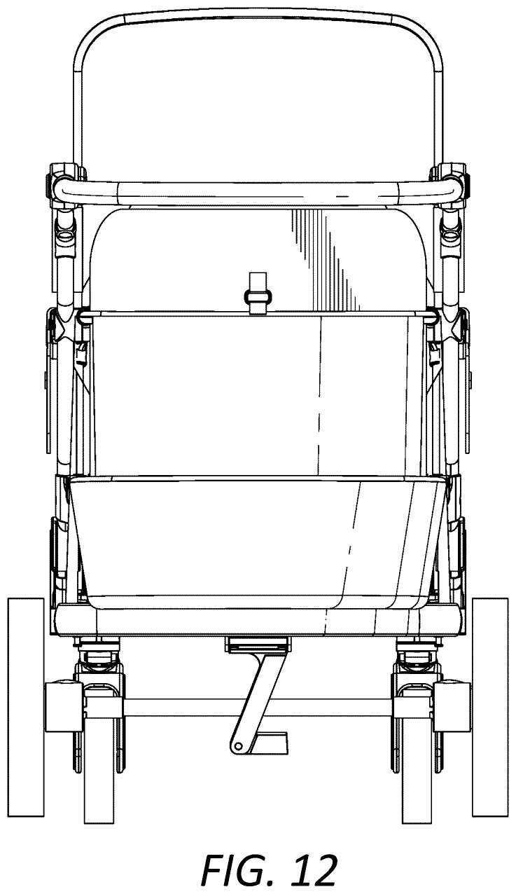

FIG. 11 is a front view of the stroller or wagon, while FIG. 12 is a rear view thereof. FIGS. 11 and 12 illustrate the offset between wheels 801 and 804, on the one hand, and wheels 802 and 803, on the other. Wheels 801 and 804 in this embodiment are positioned outside wheels 802 and 803 when viewing the stroller or wagon from the front or rear. Again, few impediments are provided in this embodiment that would inhibit the folding of the stroller or wagon as shown in the embodiment of FIGS. 1-7 described above. In one aspect, bracket 140 and the associated storage bag may be removed and the stroller or wagon folded as shown in the previous representations.

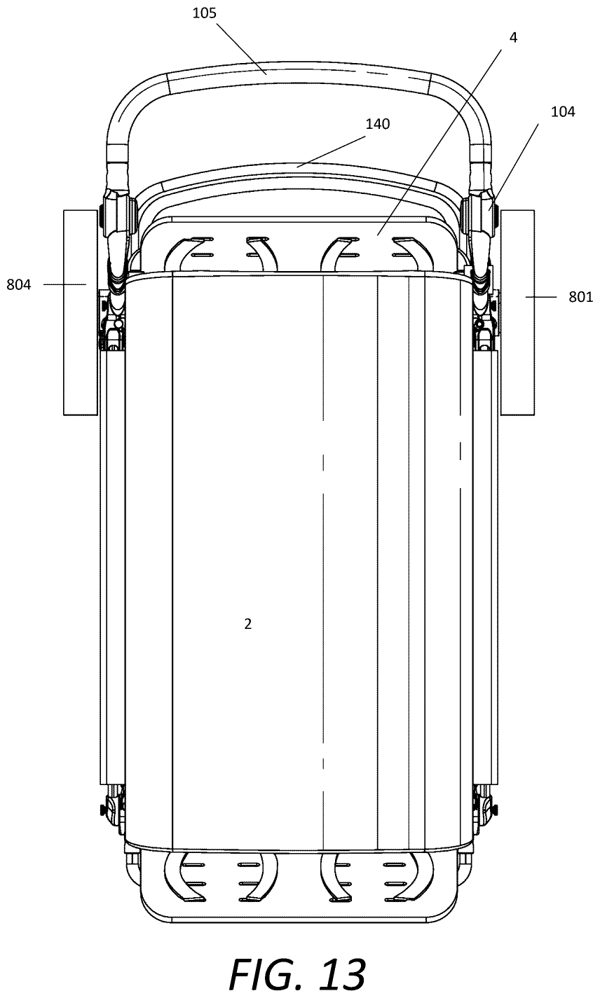

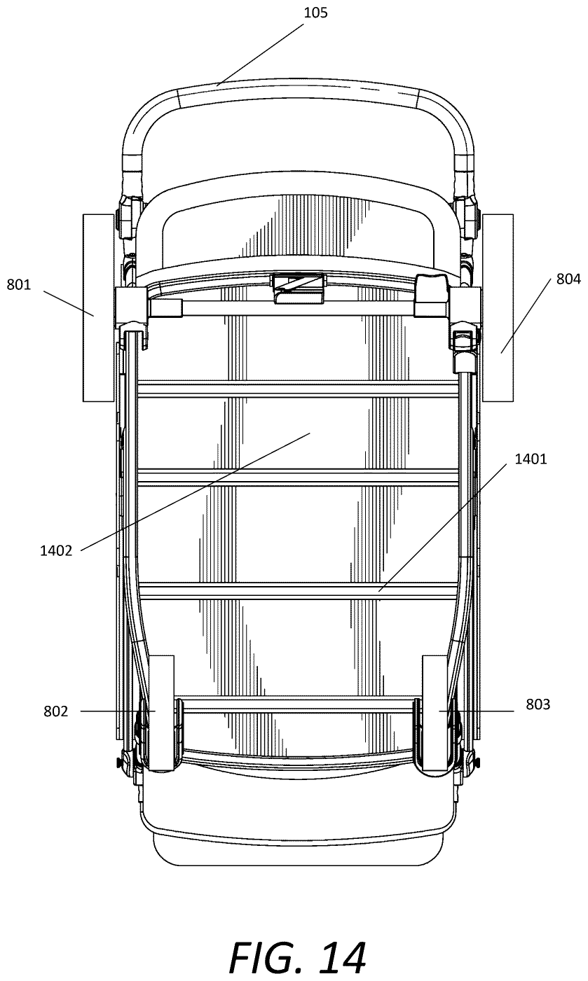

FIG. 13 is a top view of the alternate embodiment while FIG. 14 is a bottom view of the embodiment. FIG. 13 shows roof 2, seat 4, second joint 104, push handle 105, bracket 140, and wheels 801 and 804. FIG. 14 shows wheels 801 and 804 positioned toward the rear of the vehicle and wheels 802 and 803 positioned toward the front. Also identified is push handle 105 and a number of slats, such as slat 1401, that may be positioned beneath a floor element 1402. Such slats are optional and there may be more or fewer slats, and slats may be omitted if there are support elements supporting a floor or lower surface, such a support ring on the frame that fully or partially encircles a region where the floor or flat surface may be positioned. A floor may be omitted if desired, and slats not included, such as in the case of positioning young children in the available seats for transport.

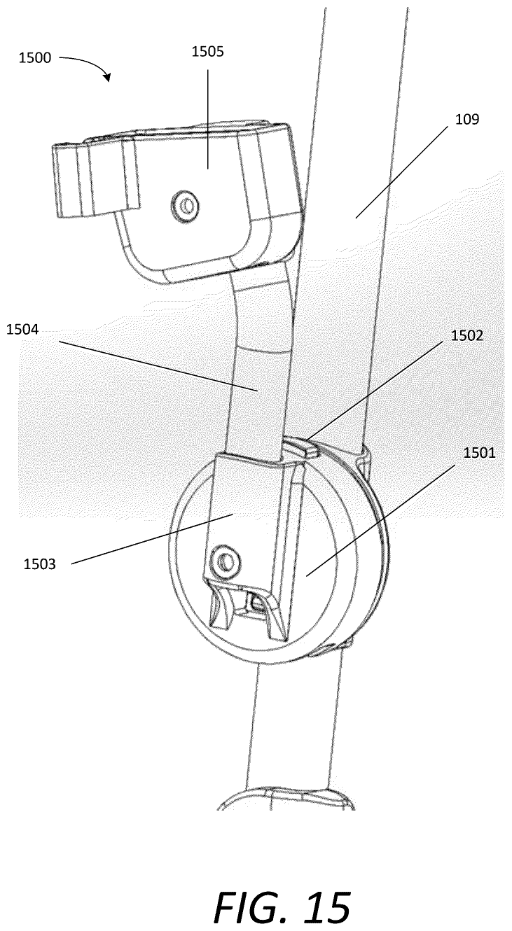

FIG. 15 shows a joint or connector 1500 that may be employed in accordance with the present design, wherein the joint is in a completely engaged state and such a joint provides enhanced functionality with respect to use, folding, and storage. From FIG. 15, there is provided an outer covering 1501 and an engagement/disengagement button 1502. When engagement/disengagement button 1502 is pressed, the outer covering separates or is separable from a lower base (not shown in this view). Receptacle 1503 is fixedly provided with outer covering 1501 and holds or maintains arm 1504. Joint or connector 1500 may slide up and down second vertical rod 109. While shown in this view on second vertical rod 109, the joint or connector 1500 may be employed on other vertical supporting or rotatable elements on the device, and more than one such joint or connector 1500 may be provided. Element 1505 may be a receiving element that may receive a variety of different appropriate apparatuses, including but not limited to receptacles, attachments, holders, collectors, and so on.

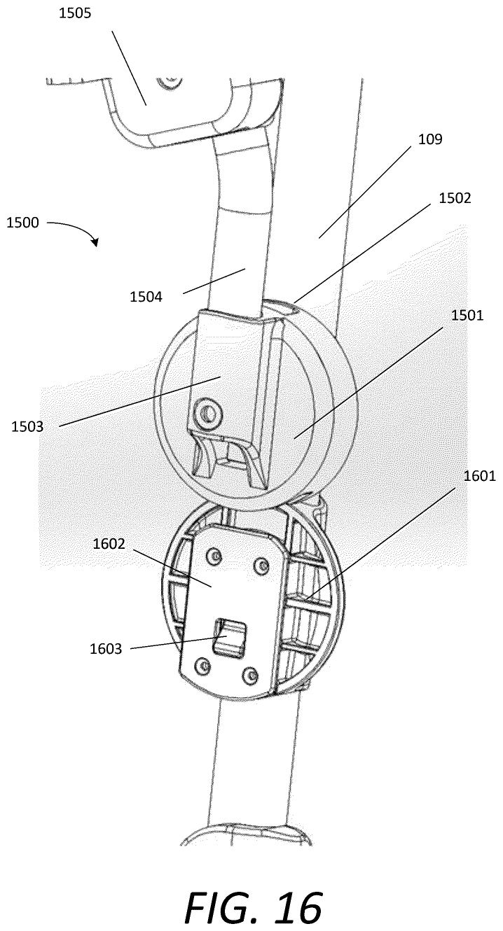

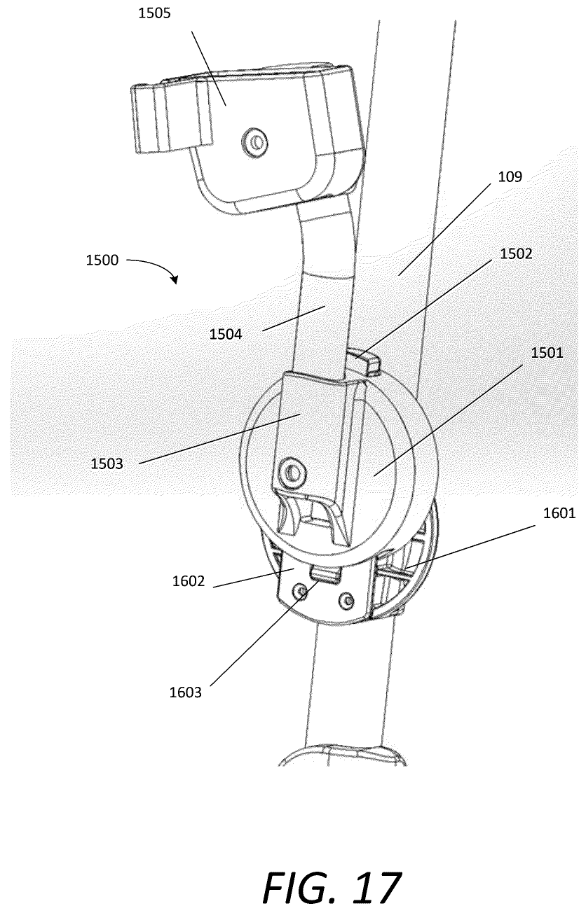

FIG. 16 shows joint or connector 1500 in a disengaged state with outer covering 1501 and receptacle 1503 separated from base 1601. Outer covering is removable by engagement of engagement/disengagement button 1502, which when pressed releases tab 1603 allowing outer covering 1501 to slide away from receiving element 1602, a generally flat surface that meets with and holds a corresponding holding element (not shown) on the reverse side of covering 1501. When in place such as shown in FIG. 15, the corresponding holding element is adjacent and maintained by receiving element 1602 with tab 1603 holding covering 1501 in place by impeding movement of covering 1501 from base 1601. FIG. 17 is a view of joint or connector 1500 partially engaged, with a portion of base 1601 showing, slowing partial sliding of covering 1501 off of receiving element 1602.

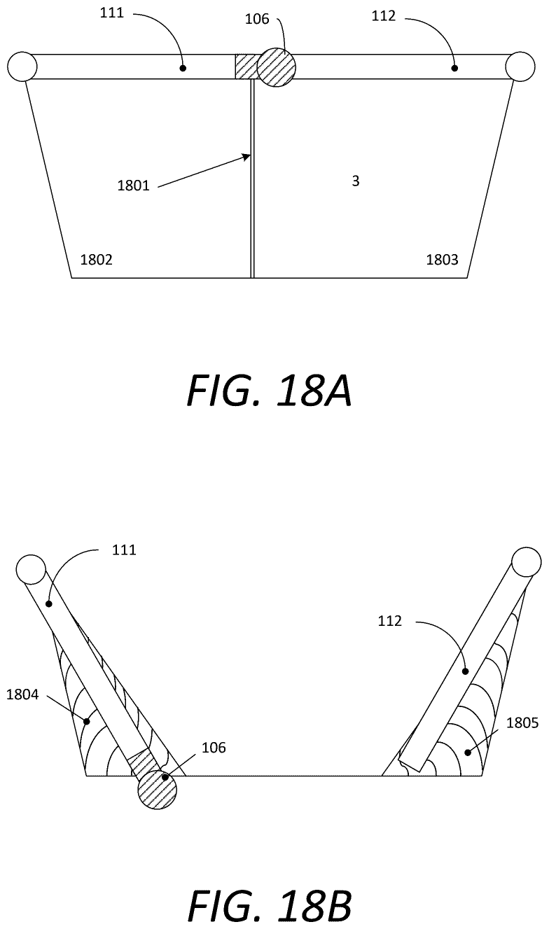

Additional attributes of the design include the following. Side doors are provided in the wagon, in the riding bag 3 illustrated in FIGS. 1 and 9, for example. The ability to fold first cross bar 111 and second cross bar 112 down when third joint 106 is released offers access to the exterior of riding bag 3. Riding bag 3 may be fitted on each side with an openable flap that may be unfolded or opened when first cross bar 111 and second cross bar 112 are folded down or retracted, enabling for example a small child to enter or exit the wagon or stroller. FIGS. 18A and 18B illustrate this aspect of the design.

FIG. 18A represents one side of riding bag 3, with first cross bar 111 and second cross bar 112 connected by third joint 106 and riding bag or enclosure 3 shown with seam 1801 provided between enclosure portions 1802 and 1803. The representation of FIG. 18A is conceptual and shows only relevant parts of the wagon or stroller but may be incorporated into one or both sides or the wagon or stroller. Seam 1801 may be secured in this representation by Velcro, such as a Velcro strip or pieces, or hooks, buttons, a zipper, or any other reasonably available releasable attachment and connecting means. FIG. 18B illustrates first cross bar 111 and second cross bar 112 released and rotated downward, providing an opening, with the riding bag 3 opened via seam 1801 being released, providing folded enclosure portions 1804 and 1805, representing opened and folded or retracted versions of enclosure portions 1802 and 1803, respectively. Internal components, such as seats or the opposing interior side of the wagon or stroller are shown in FIG. 18B. In this manner, according to this aspect of the present design, a child can enter or exit the riding bag 3 and stroller/wagon. As noted, such a construction as shown in FIGS. 18A and 18B may be offered on one or both sides of the stroller or wagon.

Another attribute of the present design includes independent bearings for the front wheels at a minimum and all four wheels in some instances. Independent wheel bearings provide ease of maneuvering and may include internal elements such as ball bearings that move easier and provide sufficient support. Further, the front wheel bearings offer additional support based on intervals between the front wheels, handle, and rear wheels such that additional weight does not cause excessive friction or resistance when pushing the device. In such a construction, larger and stronger wheels and wheel bearings are provided in the front wheels to enhance maneuverability, such as bearings including larger internal ball bearings in the independent bearings.

Thus the present design includes an arrangement for quickly and efficiently folding the device into a more compact form. Seats and flooring may be removed from the vehicle, i.e., the stroller or wagon, and the wagon folded in the manner shown in FIGS. 1-7. According to one aspect, there is thus provided a vehicle, such as a wagon or stroller, that is easy to store and fold, comprising a frame and a boat-like riding bag mounted on the frame, characterized in that two seats are mounted inside the riding bag, the frame comprises a bottom frame with movable wheels, one end of the bottom frame is rotatably mounted with two first vertical rods, the other end of the bottom frame is mounted with two rotatable second vertical rods, the upper ends between the two first vertical rods and the upper ends between the two second vertical rods are both articulated with a connecting rod. Both sides of the two seats are respectively connected to the first vertical rod and the second vertical rod through the first joint. The backrest of the seat can adjust the backrest inclination angle through the first joint, the joint between the first vertical rod and the second vertical rod is provided with a rotatable and foldable side rod. The two ends of the side rod are movably connected with support rods. A cover is installed between the two support rods, and the upper end joint between the two first vertical rods is provided with a push handle.

According to one aspect of the present design, there is provided a vehicle comprising a frame attached to a plurality of wheels, a first rotatable element and a second rotatable element connected to a front end of the frame and each rotatable with respect to the frame, a third rotatable element and a fourth rotatable element connected to a rear end of the frame and each rotatable with respect to the frame, a first rotatable, disengageable, and collapsable connecting arm arrangement rotatably mounted with the first rotatable element and the third rotatable element, a second rotatable, disengageable, and collapsable connecting arm arrangement rotatably mounted with the second rotatable element and the fourth rotatable element, and an enclosure attached to the frame.

According to a further aspect of the present design, there is provided a wagon comprising a frame, a plurality of wheels positioned beneath the frame, a first rotatable rod and a second rotatable rod connected to a front end of the frame and each rotatable with respect to the frame, a third rotatable rod and a fourth rotatable rod connected to a rear end of the frame and each rotatable with respect to the frame, a first rotatable, disengageable, and collapsable connecting arm arrangement rotatably mounted with the first rotatable rod and the third rotatable rod; a second rotatable, disengageable, and collapsable connecting arm arrangement rotatably mounted with the second rotatable rod and the fourth rotatable rod, and an enclosure positionable above the frame within an area bounded by the first rotatable rod, the second rotatable rod, the third rotatable rod, and the fourth rotatable rod.

According to another aspect of the present design, there is provided a wagon comprising a frame supported by a plurality of wheels, a first rotatable rod and a second rotatable rod connected to a front end of the frame and each rotatable with respect to the frame, a third rotatable rod and a fourth rotatable rod connected to a rear end of the frame and each rotatable with respect to the frame, a first rotatable, disengageable, and collapsable connecting arm arrangement rotatably mounted with the first rotatable rod and the third rotatable rod, and a second rotatable, disengageable, and collapsable connecting arm arrangement rotatably mounted with the second rotatable rod and the fourth rotatable rod.

Although embodiments of the present invention have been shown and described, it will be appreciated by those skilled in the art that various changes, modifications, substitutions and variations may be made to the embodiments without departing from the principles and spirit of the present invention, and that the scope of the present invention is defined by the appended claims and their equivalents.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A vehicle comprising:
a frame attached to a plurality of wheels;
a first rotatable element and a second rotatable element connected to a front end of the frame and each rotatable with respect to the frame;
a third rotatable element and a fourth rotatable element connected to a rear end of the frame and each rotatable with respect to the frame;
a first rotatable, disengageable, and collapsable connecting arm arrangement rotatably mounted with the first rotatable element and the third rotatable element;
a second rotatable, disengageable, and collapsable connecting arm arrangement rotatably mounted with the second rotatable element and the fourth rotatable element; and
an enclosure attached to the frame.

2. The vehicle of claim 1, further comprising a cover positioned over the vehicle.

3. The vehicle of claim 2, further comprising four support elements adjoining the vehicle and configured to maintain the cover above the vehicle.

4. The vehicle of claim 1, further comprising a push handle.

5. The vehicle of claim 1, wherein the first rotatable, disengageable, and collapsable connecting arm arrangement comprises:
a first cross rod; and
a second cross rod,
wherein a first end of the first cross rod interfaces a first hinge seat installed on an upper end of the first rotatable element and a first end of the second cross rod interfaces an upper end of the third rotatable element and the first cross rod and the second cross rod are connected by a disconnectable joint.

6. The vehicle of claim 5, wherein the disconnectable joint comprises:
a circular first connecting seat; and
a second connecting seat;
wherein the circular first connecting seat is fixed to an opposite end of the second cross rod and the second connecting seat is fixed to an opposite end of the first cross rod.

7. The vehicle of claim 6, further comprising an internal enclosure sealable at a seam wherein rotation of the first cross rod and the second cross rod and opening of the seam provides access to or from an interior of the wagon.

8. A wagon comprising:
a frame;
a plurality of wheels positioned beneath the frame;
a first rotatable rod and a second rotatable rod connected to a front end of the frame and each rotatable with respect to the frame;
a third rotatable rod and a fourth rotatable rod connected to a rear end of the frame and each rotatable with respect to the frame;
a first rotatable, disengageable, and collapsable connecting arm arrangement rotatably mounted with the first rotatable rod and the third rotatable rod;
a second rotatable, disengageable, and collapsable connecting arm arrangement rotatably mounted with the second rotatable rod and the fourth rotatable rod; and
an enclosure positionable above the frame within an area bounded by the first rotatable rod, the second rotatable rod, the third rotatable rod, and the fourth rotatable rod.

9. The wagon of claim 8, further comprising a cover positioned over the wagon.

10. The wagon of claim 9, further comprising four support elements adjoining the wagon and configured to maintain the cover above the wagon.

11. The wagon of claim 8, further comprising a push handle.

12. The wagon of claim 8, wherein the first rotatable, disengageable, and collapsable connecting arm arrangement comprises:
a first cross rod; and
a second cross rod,
wherein a first end of the first cross rod interfaces a first hinge seat installed on an upper end of the first rotatable element and a first end of the second cross rod interfaces an upper end of the third rotatable element and the first cross rod and the second cross rod are connected by a disconnectable joint.

13. The wagon of claim 12, wherein the disconnectable joint comprises:
a circular first connecting seat; and
a second connecting seat;
wherein the circular first connecting seat is fixed to an opposite end of the second cross rod and the second connecting seat is fixed to an opposite end of the first cross rod.

14. The wagon of claim 12, further comprising a sleeve fixed to the first connecting seat and the second connecting seat, wherein one end of the sleeve is sleeved on the first cross rod and fixed on the second cross rod.

15. A wagon comprising:
a frame supported by a plurality of wheels;
a first rotatable rod and a second rotatable rod connected to a front end of the frame and each rotatable with respect to the frame;
a third rotatable rod and a fourth rotatable rod connected to a rear end of the frame and each rotatable with respect to the frame;
a first rotatable, disengageable, and collapsable connecting arm arrangement rotatably mounted with the first rotatable rod and the third rotatable rod; and
a second rotatable, disengageable, and collapsable connecting arm arrangement rotatably mounted with the second rotatable rod and the fourth rotatable rod.

16. The wagon of claim 15, further comprising a cover positioned over the wagon.

17. The wagon of claim 16, further comprising four support elements adjoining the wagon and configured to maintain the cover above the wagon.

18. The wagon of claim 15, further comprising a push handle.

19. The wagon of claim 15, wherein the first rotatable, disengageable, and collapsable connecting arm arrangement comprises:
a first cross rod; and
a second cross rod,
wherein a first end of the first cross rod interfaces a first hinge seat installed on an upper end of the first rotatable element and a first end of the second cross rod interfaces an upper end of the third rotatable element and the first cross rod and the second cross rod are connected by a disconnectable joint.

20. The wagon of claim 19, further comprising an internal enclosure sealable at a seam wherein rotation of the first cross rod and the second cross rod and opening of the seam provides access to or from an interior of the wagon.
